(19) United States
(12) Patent Application Publication
(10) Pub. No.: US 2005/0280659 A1
(43) Pub. Date: Dec. 22, 2005

(54) Display controller bandwidth and power reduction

(76) Inventor: Nigel C. Paver, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/870,899

(22) Filed: Jun. 16, 2004

(51) Int. Cl. G09G 5/00

(52) U.S. Cl. 345/629

(57) ABSTRACT

Apparatus, systems and methods for providing display bandwidth and power reduction are disclosed. In one implementation, a display controller may treat overlay layer image data as non-transparent and to fetch only base layer image data that will not be overlain. In another implementation, a display controller may auto detect when an overlay layer is sized to fill the display screen and supply only overlay layer image data to a display. In another implementation, a display controller may substitute a constant color value for base layer image data and combine that constant color value with overlay layer data when providing image data to a display.

### BACKGROUND

When a computing system renders an image for display that image may typically be fetched from computer memory where it is stored as data specifying a color and intensity for each pixel of the image. A display controller typically fetches the image data from memory and renders it for display.

The displayed image may be formed by combining a background “base layer,” such as the Operating System's (OS) “desktop,” with a foreground “overlay layer,” such as a window containing streaming video imported into the computer system from an external source. Often the overlay layer occupies less than an entire display frame, thus overlapping only a portion of the base layer. Sometimes, however, the overlay layer fills the entire display frame, completely overlapping the base layer.

Typical controllers use distinct hardware “engines” to fetch the base and overlay layer data from memory as pixel streams. The controller then combines the fetched pixel streams to generate a single stream of pixels forming the displayed image. Most display controllers also support layer transparency where the overlay layer can be translucent to varying degrees. Usually, the overlay layer's pixel data specifies the degree, if any, of overlay transparency. When transparency is specified the controller combines and/or “blends” the underlying base layer data with the overlay layer for that pixel. Because the typical display controller does not know ahead of fetching the overlay layer data if transparency will be specified it typically fetches the base layer pixel data just in case transparency is specified.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system;

FIG. 2 illustrates the display controller and some other components of the system of FIG. 1 in more detail;

FIG. 3 illustrates the registers of the display controller of FIG. 2 in more detail;

FIG. 4 is a flow chart illustrating a process of designating an overlay non-transparent;

FIG. 5 is a flow chart illustrating a process of auto detecting full screen overlays; and

FIG. 6 is a flow chart illustrating a process of providing a constant base layer color value.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art, having the benefit of the present disclosure, that the various aspects of the invention claimed may be practiced in other examples that depart from these specific details. In certain instances, descriptions of well known devices, circuits, and methods are omitted so as not to obscure the description of the present invention with unnecessary detail.

FIG. 1 illustrates an example system 100. Example implementations of system 100 may include a mobile computer, a portable digital device such as a personal digital assistant (PDA), a mobile telephone (e.g., a cell phone), a consumer electronics device, a general-purpose computer or another electrical system, although the claimed invention is not limited in this regard. Although system 100 may be embodied in a single device, in some implementations certain components of system 100 may be remote and/or physically separated from other components of system 100. Further, although system 100 is illustrated as including discrete components, these components may be implemented in hardware, software/firmware, or some combination thereof. When implemented in hardware, some components of system 100 may be combined in a certain chip or device.

System 100 may include a processor 102, memories 104A and 104B, a bus 106, an I/O interface 108, a network interface 109, a display controller 110, and a liquid crystal display (LCD) 112. Processor 102 may be coupled to bus 106 for communicating with other system devices such as memories 104A and 104B and display controller 110. Processor 102 may comprise a general purpose processor or a specific purpose processor generally arranged to control other elements in system 100 such as display controller 110. Processor 102 may include logic to perform specific functions within system 100 such as enabling transfer of data between I/O interface 108 and memory 104A, although the invention is not limited in this regard.

In the implementation of FIG. 1 memories 104A and 104B may comprise random access memory (RAM), although the invention is not limited in this regard and may comprise other types of memory such as non-volatile memory (e.g., flash memory). Although shown as two physically distinct units, memories 104A and 104B may in fact be logical portions of one physical memory device or may be embedded within another device such as processor 102 or controller 110, although the invention is not limited in this regard.

Display 112 may display multiple “layers” of image data including a base layer region 114 and an overlay layer region 116 overlying base layer region 114. In some implementations only a portion 115 of base layer region 114 that is not overlain by overlay region 116 appears on display 112. In some implementations the base layer data corresponding to the portion of base layer 114 overlain by overlay layer 116 may be combined and/or blended with the overlay data in region 116. As will be further described below, display controller 110 may be configured to provide the image data displayed on LCD 112. While system 100 may include an LCD 112 as shown in FIG. 1, system 100 may include another type of display such as an organic light-emitting diode (OLED), without departing from the scope or spirit of the invention.

Bus 106 may be a peripheral component interconnect (PCI) bus, although the invention is not limited in this respect. I/O interface 108 may permit processor 102 or display controller 110 to communicate with I/O devices (not shown) such as, for example, a Bluetooth® wireless universal asynchronous receiver/transmitter (UART) or a universal serial bus (USB) linked to a digital camera, although the invention is not limited in this regard.

While RAM memories 104A,B and display controller 110 may be physically separated from processor 102 the invention is not limited in this respect and encompasses, for example, embodiments wherein memory and/or the display controller are embedded within processor 102. Moreover, all components or portions of the components of system 100 may be incorporated within a single integrated circuit (IC) “system on a chip” or incorporated into a collection of IC's interconnected to form a “package” without departing from the scope or spirit of the claimed invention.

Both I/O interface 108 and network interface 109 may comprise any suitable interface controllers to provide for any suitable communication link to different components of the system 100. For example, I/O interface 108 may communicatively couple system 100 to one or more suitable integrated drive electronics (IDE) drives, such as a hard disk drive (HDD) or optical disc drive (e.g., CD-ROM, CD-R/W, DVD-R, DVD-R/W, etc.), to store still or video image data and/or software instructions, for example. I/O interface 108 may, in some implementations, also communicatively couple system 100 to one or more suitable universal serial bus (USB) devices through one or more USB ports, an audio coder/decoder (codec), and a modem codec. I/O interface 108 may, in some implementations, also provide an interface to a keyboard, a mouse, and one or more suitable devices, such as a printer for example, through one or more ports. Network interface 109 may provide an interface to one or more networks external to system 100, including, for example, a local area network (LAN) permitting system 100 to be communicatively coupled, for example, to external sources providing streaming video data. In other implementations network interface 109 may interface with a wireless network, for example, a wireless LAN.

FIG. 2 illustrates the display controller and some other components of the system of FIG. 1 in more detail. Display controller 110 may include a base layer access engine 202, an overlay layer access engine 204, a combining circuit 206, a control register 208, and a base value register 210. In some implementations access engines 202 and 204 may comprise direct memory access (DMA) engines, although the invention is not limited in this regard. Base layer engine 202 and overlay layer engine 204 may be communicatively coupled with RAM 104A and RAM 104B through bus 106. In one implementation, base layer engine 202 may fetch and/or obtain base layer data from RAM 104A and overlay layer engine 204 may fetch and/or obtains overlay layer data from RAM 104B.

In some implementations, however, engines 202 and 204 may fetch image data stored on any combination of RAM 104A or RAM 104B, including, for example, fetching both base and overlay data stored on RAM 104B, without departing from the scope or spirit of the invention. Moreover, in some implementations, engines 202 and 204 may fetch their respective layer data from memory internal to either controller 110 and/or processor 102 without departing from the scope or spirit of the invention. In some implementations, control register 208 may control how base layer engine 202 may fetch base layer data and how overlay layer engine 204 may fetch overlay layer data.

Controller 110 may combine the fetched base and overlay pixel data in combining circuit 206 and provide the resulting pixels to LCD 112 as combined image data. In some implementations when the overlay data does not specify transparency, controller 110 may control circuit 206 to pass to LCD 112 that base layer pixel data for portion 115 of base region 114 that will not be overlain by region 116. In some implementations controller 110 may control circuit 206 to pass to LCD 112 substantially only that base layer pixel data for portion 115 of base region 114 that will not be overlain by region 116. In other words, in those implementations, controller 110 may control circuit 206 to pass to LCD 112 insubstantial portions of base layer pixel data corresponding to portions of base region 114 that are overlain by region 116.

In some implementations, controller 110 may control circuit 206 to supply only overlay layer pixel data to LCD 112 when displaying region 116. In some implementations, controller 110 may control circuit 206 to supply substantially only overlay layer pixel data to LCD 112 when displaying region 116. In other words, in those implementations, controller 110 may control circuit 206 to pass to LCD 112 insubstantial portions of base layer pixel data corresponding to base region 114 in addition to controlling control circuit 206 to supply overlay layer pixel data to LCD 112 when displaying region 116.

In some implementations when the overlay data specifies transparency, controller 110 may control circuit 206 to blend the overlay data with the base data to the specified degree of transparency when supplying data for the region of LCD 112 corresponding to overlay region 116. When displaying portion 115 of region 114, controller 110 may control circuit 206 to pass only the base layer pixel data to LCD 112.

FIG. 3 illustrates registers 208 and 210 of display controller 110 in more detail. In the implementation of FIG. 3, control register 208 may contain a number of control bits or indicators, three of which, B1, B2, and B3 may be used to control the combining of base and overlay layer pixel data. Bits B1-B3 may be set and/or enabled by software that is implemented as instructions stored in RAM 104A,B and executed by processor 102. Not all of bits B1-B3 need be present in every implementation of the invention. In some implementations, bits B1-B3 may be set by processor 102 in response to software implemented as instructions, or groups of instructions, implemented in a machine-readable medium such as a CD-ROM and accessed over I/O interface 108.

In some implementations bit B1 may control whether display controller 110 fetches or obtains base layer data for those pixels of display 112 corresponding to the area of base layer 114 overlain by overlay layer 116. For example, when the overlay data will not be transparent or translucent, processor 102 may set bit B1 to instruct controller 110 to fetch base layer data corresponding only to portion 115 of base layer 114 using engine 202. In some implementations processor 102 may set bit B1 to instruct controller 110 to fetch base layer data corresponding substantially only to portion 115 of base layer 114. In other words, processor 102 may set bit B1 to instruct controller 110 to fetch insubstantial or small portions of base layer data corresponding to portions of base layer 114 overlain by overlay layer 116 in addition to instructing controller 110 to fetch base layer data corresponding to portion 115 of base layer 114.

In some implementations bit B2 may control whether controller 110 “auto detects” that the overlay data will completely fill the frame or displayable screen area of LCD 112 (i.e., when region 116 fills LCD 112 and thus completely overlaps region 114). Thus, in those implementations, when bit B2 is set or enabled and controller 110 detects that the overlay data fills an entire frame of LCD 112 then controller 110 may fetch only overlay data using engine 204. When bit B2 is not set and/or is disabled, controller 110 may fetch both base and overlay data and provide that data to LCD 112 as described above. In some implementations when bit B2 is set or enabled and controller 110 detects that the overlay data fills an entire frame of LCD 112 then controller 110 may fetch substantially only overlay data using engine 204. In other words, in those implementations, when bit B2 is set or enabled and controller 110 detects that the overlay data fills an entire frame of LCD 112 then controller 110 may fetch insubstantial portions of base layer data using engine 202 in addition to fetching overlay data using engine 204.

In some implementations bit B3 may control whether controller 110 substitutes a constant color value for the base layer data. For example, when the overlay data is of a type that makes the base layer less important, such as when the overlay layer comprises a preview image imported from a digital camera, control bit B3 may be set, enabling and/or instructing display controller 110 to supply a constant color value for the base layer data. Thus, when bit B3 is set, controller 110 may obtain overlay data when providing data for that portion of LCD 112 corresponding to the overlay region 116 and otherwise may provide a constant color value stored in base value register 210 when providing data for that portion 115 of LCD 112 corresponding to the base region 114 not overlain by region 116. In some implementations, when transparency and/or translucency of region 116 is indicated and when bit B3 is enabled, controller 110 may combine and/or blend the constant color value with the overlay image data in region 116.

While FIGS. 2 and 3 show distinct control and base value registers 208 and 210 respectively, other schemes and apparatus for enabling controller 110 to disable overlay transparency, auto detect full screen overlays, and to provide constant color values for the base layer can be implemented without departing from the scope and spirit of the claimed invention. For example, the control bits B1, B2, and B3 as well as the data bits specifying the constant base color value can be held in a single, general purpose register or may be stored in external memory.

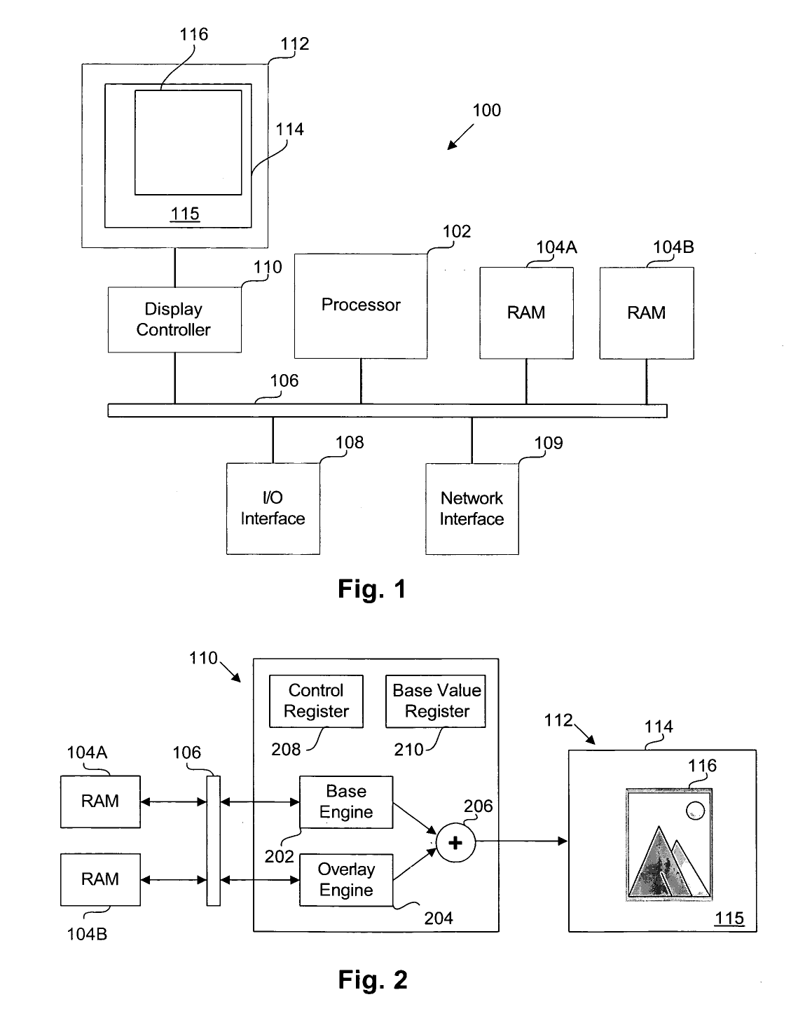

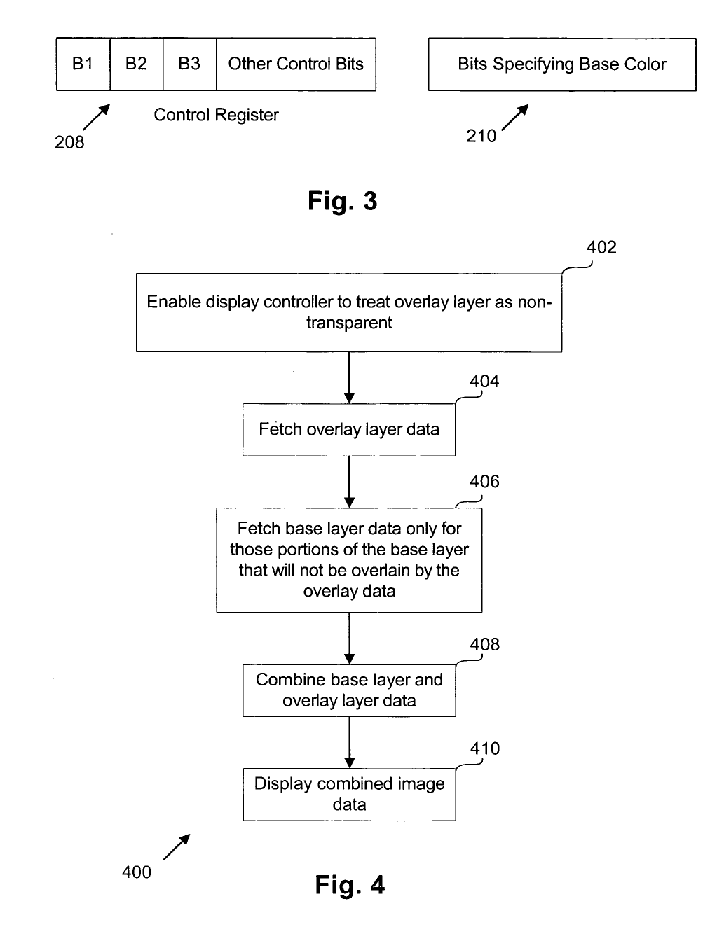

FIG. 4 is a flow chart illustrating a process 400 of designating an overlay as non-transparent. Although process 400 may be described with regard to system 100 for ease of explanation, the claimed invention is not limited in this regard. Processing may begin with enabling display controller 110 to treat the overlay layer as non-transparent and/or opaque [act 402]. One way to do this may be to set control bit or indicator B1 to indicate that display controller 110 should treat overlay layer as opaque or non-transparent. Processing may continue with display controller arranging for overlay layer engine 204 to fetch overlay layer data from RAM 104B [act 404].

In response to the indication that the overlay is non-transparent at act 402, indicated, for example, by the setting of bit B1, display controller 110 may arrange for base layer engine 202 to fetch from RAM 104A the base layer data for only that portion 115 of base layer region 114 that will not be overlain by overlay layer region 116 [act 406]. Processing may continue with controller 110 combining base layer data corresponding to portion 115 of region 114 with the overlay layer data using circuit 206 [act 408] and displaying the resulting combined image data on LCD 112 [act 410].

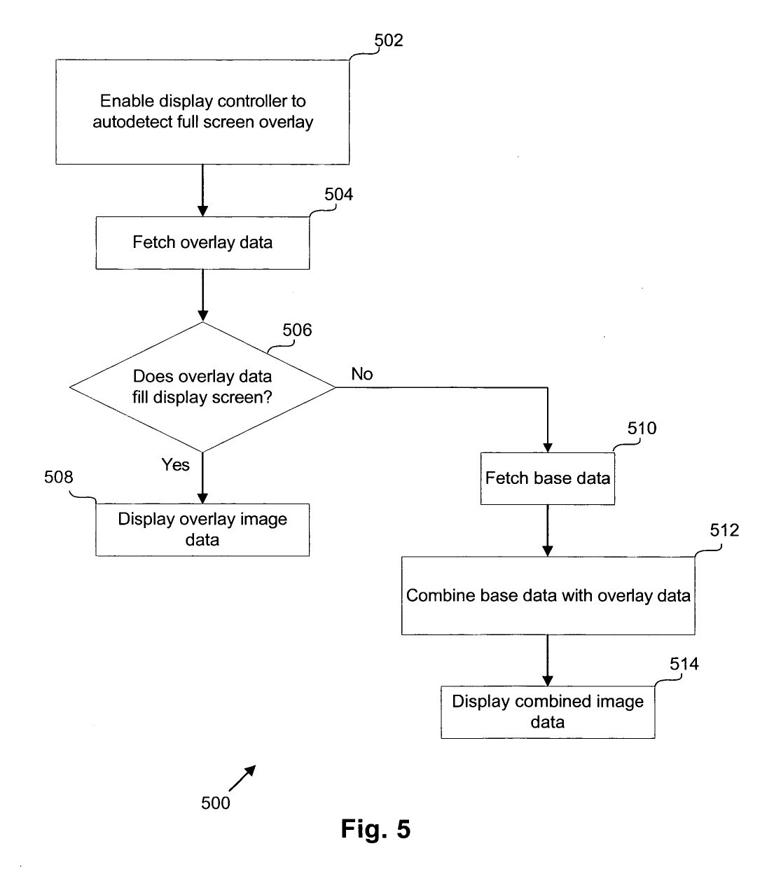

FIG. 5 is a flow chart illustrating a process 500 of auto detecting full screen overlays. Although process 500 may be described with regard to system 100 for ease of explanation, the claimed invention is not limited in this regard. Processing may begin with the enabling of display controller 110 to auto detect when overlay layer 116 fills the entire display area or screen of LCD 112 [act 502]. One way to do this is by setting control bit or indicator B2. Processing may continue with controller 110 arranging for overlay layer engine 204 to fetch overlay layer data from RAM 104B [act 504].

In response to the enabling of full screen overlay auto detection in act 502, by, for example, the setting of bit B2, display controller 110 may detect whether the overlay layer data fetched in act 504 will fill the screen of LCD 112 [act 506]. If controller 110 determines that the overlay layer data fills the screen of LCD 112 (i.e., overlay layer region 116 completely overlaps base layer region 114) then controller may not fetch base layer data and may, instead, display only overlay data as the image on LCD 112 [act 508]. If, however, controller 110 determines that the overlay layer data does not fill the screen of LCD 112 (i.e., overlay layer region 116 does not completely overlap base layer region 114) then controller may arrange for base layer engine 202 to fetch base layer data from RAM 104A [act 510]. Controller 110 may then combine the base and overlay layer data using circuit 206 [act 512] and may display the resulting combined image data on LCD 112 [act 514].

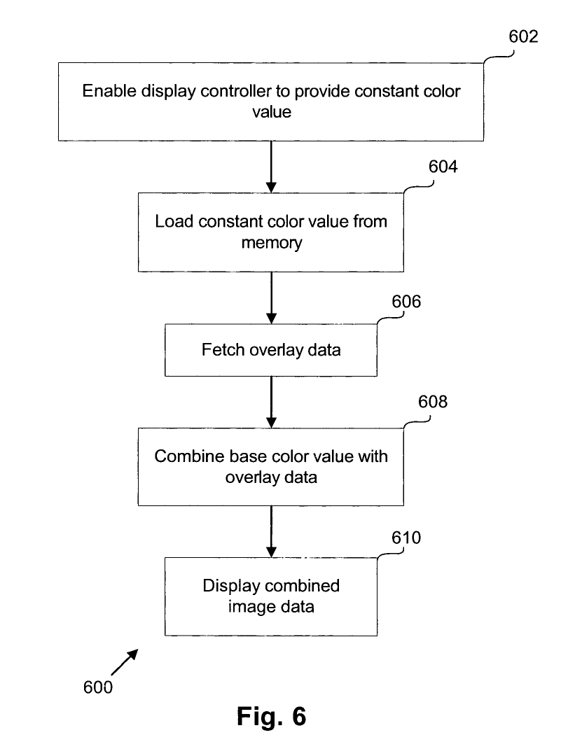

FIG. 6 is a flow chart illustrating a process 600 for enabling controller 110 to provide a constant base layer color value. Although process 600 may be described with regard to system 100 for ease of explanation, the claimed invention is not limited in this regard. Processing may begin with the enabling of display controller 110 to provide a constant color value for the base layer data corresponding to the base layer region 114 [act 602]. One way to do this is by setting control bit or indicator B3. Processing may continue with the loading of a constant color value from memory [act 604]. One way to do this is by loading a base color value stored in base color value register 210.

In some implementations, the color value loaded in act 604 may be consistent with an 18-bit red-green-blue (RGB) color value format, although the invention is not limited in this respect and other color values may be loaded in memory that are consistent or compatible with the color format of LCD 112. Controller 110 may then arrange for overlay layer engine 204 to obtain overlay layer data from RAM 104B [act 606]. Display controller 110 may then combine the base color value with overlay layer data using circuit 206 [act 608] and may display the resulting combined image data on LCD 112 [act 610].

The acts shown in FIGS. 4, 5 and 6 need not be implemented in the order shown; nor do all of the acts necessarily need to be performed. For example, in process 600 the act of obtaining the overlay data may be performed before the act of loading a constant color value from memory. Also, those acts that are not dependent on other acts may be performed in parallel with the other acts. Further, at least some of the acts in this figure may be implemented as instructions, or groups of instructions, implemented in a machine-readable medium.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention.

For example, the system, apparatus and methods for display controller bandwidth and power reduction described herein are not limited to systems or apparatus where the display controller communicates image data to the display over buses or cables. Rather, the claimed invention also contemplates display controllers that communicate with displays using wireless technologies. Also, although described in terms of a discrete display controller, in some implementations the display controller may be imbedded within a larger general purpose processor or system. For example, the display controller may be embedded along with a processor, buses, I/O interfaces, etc., within a single integrated circuit chip or a “system on a chip.” Clearly, many other implementations may be employed to provide for display controller bandwidth and power reduction consistent with the claimed invention.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

1. A system comprising:
memory to store image data, the image data including base image data and overlay image data specifying at least color data for pixels of a displayed image;
a display controller communicatively coupled to the memory, the controller to fetch the base image data and overlay image data from memory; and
at least one indicator configurable to instruct the controller to:
fetch base image data substantially only when the base image data will not be overlain by the overlay image data, and
fetch substantially only overlay image data when the overlay image data is sized to fill a display screen.

2. The system of claim 1, wherein the at least one indicator is further configurable to instruct the controller to supply a constant color value in place of fetching base image data.

3. The system of claim 1, further comprising:
a display operatively and communicatively coupled to the controller.

4. The system of claim 1, wherein the at least one indicator comprises at least one data bit readable by the display controller.

5. The system of claim 4, wherein the at least one data bit is held in a register communicatively coupled to the display controller.

6. The system of claim 1, further comprising:
a processor to configure the at least one indicator.

7. An apparatus comprising:
a display controller for displaying base pixel data and overlay pixel data; and
at least one indicator configurable to instruct the controller to;
obtain only overlay pixel data when the overlay pixel data will fill a display screen, and
apply a constant color value rather than obtaining base pixel data.

8. The apparatus of claim 7, wherein the at least one indicator is further configurable to instruct the controller to not obtain base pixel data when base pixel data that will be overlain by overlay pixel data.

9. The apparatus of claim 7, wherein the at least one indicator comprises at least one data bit readable by the display controller.

10. The apparatus of claim 9, wherein the at least one data bit is held in a register communicatively coupled to the display controller.

11. The apparatus of claim 7, further comprising:
a memory to store content, at least a subset of which is executable content; and
control logic, communicatively coupled with the memory, to selectively execute at least a subset of the executable content, to implement configuration of the at least one indicator.

12. A method comprising:
setting a first indicator; and
fetching image data from memory;
wherein the image data comprises base image data and overlay image data specifying at least image color for pixels of a display;
wherein, in response to setting the first indicator, fetching image data comprises fetching substantially only that base data image that specifies image data for pixels of the display not specified by the overlay image data.

13. The method of claim 12, further comprising:
resetting the first indicator;
wherein, in response to resetting the first indicator, fetching image data comprises fetching all base image data.

14. The method of claim 12, further comprising:
setting a second indicator;
wherein, in response to setting the second indicator, fetching image data comprises fetching substantially only overlay image data when the overlay image data specifies all pixels of the display.

15. The method of claim 14, further comprising:
resetting the second indicator;
wherein, in response to resetting the second indicator, fetching image data comprises fetching base image data regardless of whether the overlay image data specifies all pixels of the display.

16. The method of claim 12, further comprising:
setting a third indicator;
wherein, in response to setting the third indicator, fetching image data comprises fetching substantially only overlay image data.

17. The method of claim 16, further comprising:
supplying a constant color value for pixels other than those pixels specified by the overlay image data.

18. The method of claim 14, further comprising:
resetting the third indicator;
wherein, in response to resetting the third indicator, fetching image data comprises fetching both base image data and overlay image data.

19. A machine-accessible medium including instructions that, when executed, cause a machine to:
enable a first indicator; and
obtain image data from memory,
wherein the image data comprises base image data and overlay image data specifying at least image color for pixels of a display;
wherein, in response to enabling the first indicator, the machine obtains base image data only when the overlay image data and the base image layer specify image data for different pixels of the display.

20. The machine-accessible medium of claim 19, further including instructions that, when executed, cause a machine to:
disable the first indicator;
wherein, in response to disabling the first indicator, the machine obtains all base image data and overlay image data.

21. The machine-accessible medium of claim 19, further including instructions that, when executed, cause a machine to:
enable a second indicator;
wherein, in response to enabling the second indicator, the machine obtains only overlay image data when the overlay image data specifies all pixels of the display.

22. The machine-accessible medium of claim 21, further including instructions that, when executed, cause a machine to:
disable the second indicator;
wherein, in response to disabling the second indicator, the machine obtains both base image data and overlay image data.

23. The machine-accessible medium of claim 19, further including instructions that, when executed, cause a machine to:
enable a third indicator;
wherein, in response to enabling the third indicator, the machine obtains only overlay image data.

24. The machine-accessible medium of claim 23, further including instructions that, when executed, cause a machine to:
supply a constant color value for all pixels other than those pixels specified by the overlay image data.

25. The machine-accessible medium of claim 23, further including instructions that, when executed, cause a machine to:
disable a third indicator;
wherein, in response to disabling the third indicator, the machine obtains both base image data and overlay image data.

26. An apparatus comprising:
memory to store image data; and
a display controller;
wherein the display controller retrieves from memory only that image data that will be viewable when displayed.

27. The apparatus of claim 26 wherein the image data comprises base layer and overlay layer data.

28. The apparatus of claim 27 wherein the display controller substitutes a constant color value for the base layer data rather than retrieving the base layer data from memory.

29. The apparatus of claim 26 wherein the display controller retrieves only the overlay layer data from memory.
